(19) United States
(12) Patent Application Publication
(10) Pub. No.: US 2020/0141147 A1
(43) Pub. Date: May 7, 2020

(54) BICYCLE PARKING DEVICE

(71) Applicant: China Jiliang University, Zhejiang (CN)

(72) Inventors: Zhao Mingyan, Zhejiang (CN); Li Yixin, Zhejiang (CN)

(21) Appl. No.: 16/675,556

(22) Filed: Nov. 6, 2019

(30) Foreign Application Priority Data
Nov. 7, 2018 (CN) 201811317507.4

(51) Int. Cl. E04H 6/22; B62H 3/08; E04H 6/28; E04H 6/00

(52) U.S. Cl. CPC E04H 6/22; B62H 3/08; E04H 6/426; E04H 6/005; E04H 6/28

(57) ABSTRACT

For parking a bicycle, a bicycle parking device includes a storage tray, a lifting mechanism, and a rotary platform. The storage tray is located at the bottom of the bicycle parking device, and has a plurality of bicycle parking spaces. The lifting mechanism drives a bicycle carrying platform to move up and down. The rotary platform that is rotatably disposed on the lifting mechanism, and is docked with the bicycle parking space. The bicycle carrying platform transfers between the bicycle parking space and the rotary platform

### CROSS-REFERENCE TO RELATED APPLICATIONS

This patent application claims priority to Chinese Patent Application No. 201811317507.4 filed on Nov. 7, 2018 for Zhao Mingyan, the entire contents of which are incorporated herein by reference for all purposes. See MPEP § 201.14.

### FIELD

The invention relates to the technical field of public facilities, in particular to an underground public bicycle parking device.

### BACKGROUND

### Description of the Related Art

There may not be sufficient surface space bicycle parking.

### BRIEF DESCRIPTION OF THE DRAWINGS

FIG. 1 is a perspective drawing illustrating one embodiment of a bicycle parking device;

FIG. 2 is a perspective drawing illustrating one embodiment of a bicycle parking device lifting state;

FIG. 3 is a perspective drawing illustrating one embodiment of a bicycle parking device with a rotatory platform docking with a bicycle parking space;

FIG. 4 is a perspective drawing illustrating one embodiment of a bicycle carrying platform;

FIG. 5 is a perspective drawing illustrating one embodiment of a lifting platform coordinating with a rotary platform;

FIG. 6 is a perspective drawing illustrating one embodiment of a rotary platform; and

FIG. 7 is a perspective drawing illustrating one embodiment of a bottom plate of a lifting platform.

### DETAILED DESCRIPTION

China is the world's largest bicycle country, with more than 450 million bicycles. With the increasing number of shared bicycles, the problem of parking is becoming more and more serious. Provincial governments have to reduce the number of shared bicycles. In the past, the bicycle is mainly parked on the ground of a designated area. The parking has become a trouble in provincial development. On the one hand, it promotes green travel, while on the other hand, there are not enough suitable parking spacea for bicycles. One of the most important reasons is that the space location has not been effectively utilized, especially the use of underground space. If the space location can be effectively utilized, the parking problem of the bicycle can be alleviated.

With the advancement of urban green transportation infrastructure construction, many cities have built public bicycle sheds, using public parking pillar. However, as mentioned above, a large number of public bicycles occupy a large urban public space, or, due to space constraints, the layout of public bicycle spaces is limited, which is inconvenient to return the bicycle when the parking spaces are full.

In order to solve the problem, the embodiments park bicycles under the ground, so as to reduce the space occupied.

The underground public bicycle parking device includes:

A storage tray is located at the bottom of the bicycle parking device, and has a plurality of bicycle parking spaces. A lifting mechanism that drives the bicycle carrying platform to move up and down to realize taken and parking of the bicycle. A rotary platform that is rotatably disposed on the lifting mechanism, and is docked with the bicycle parking space by rotation. A bicycle carrying platform for parking the bicycle that transfers between the bicycle parking space and the rotary platform.

Optionally, an electronically controlled lock for locking the bicycle is disposed on the bicycle carrying platform. The electronically controlled lock is connected to the controller, and the controller detects the state of the electronically controlled lock and user data, and it is transmitted to the background. The background can count billable hours.

When user wants to park bicycle, the vacant bicycle carrying platform is placed on the rotary platform, and the lifting mechanism is raised to the ground. The bicycle is placed on the bicycle carrying platform. Subsequently the bicycle carrying platform which carrying the bicycle is lowered to the storage tray by the lifting mechanism. The rotary platform is rotated to dock with the corresponding vacant bicycle parking space, and the bicycle carrying platform on the rotary table is pushed into the bicycle parking space.

When the bicycle is taken, the bicycle carrying platform carrying the bicycle is brought into the rotating plate, and the bicycle is transported to the ground by the lifting mechanism.

Optionally, the lifting mechanism includes the first lifting screw, the second lifting screw and lifting platform. The first lifting screw and the second lifting screw are vertical setting. Both sides of the lifting platform respectively match up the first lifting screw and the second lifting screw. When the first lifting screw and the second lifting screw rotate, they drive the lifting platform up and down.

Optionally, the central part of the storage tray has an installation position, and the lifting mechanism is set at the installation position, and the lifting channel of the lifting mechanism is formed in the vertical direction of the installation position.

Optionally, the guide limit rail forms the bicycle parking space. The guide limit rail 2-2 can guide the bicycle carrying platform in and out, and limit the bicycle carrying platform.

Optionally, the rotary platform includes rotating plate, translation screw, push block, supporting plate and guide board. The translation screw, push block and supporting plate are installed on the rotating plate. The translation screw through the push block. The guide board set on the both sides of the rotating plate. The supporting plate coordinates with the bicycle carrying platform. The supporting plate is attached to the guide board, and is located at the both sides of the push block. The translation screw rotates, so that the push block moves, and push bicycle carrying platform moves.

Optionally, a push block and bicycle carrying platform are detachable connection. The push block set an electromagnet. The electromagnet may attract the bicycle carrying platform when the electromagnet is powered on. The contact parts of bicycle carrying platform and push block are made of magnetic materials.

Optionally, the bicycle carrying platform includes a bicycle placement plate, a front wheel clamping structure and a rear wheel clamping structure. The front wheel clamping structure and the rear wheel clamping structure are set in the bicycles placed plate.

Optionally, the storage tray is disk-shaped, and the bicycle parking space is distributed along the radial direction of the storage tray.

Compared with the prior art, the invention has the following advantages: the bicycle is parked in the underground space. And the device only needs to occupy the position of the rotary platform on the ground. The taking and parking of the bicycle may be completed by automated machinery, which reduces the occupation of the ground space. The device improves the space use ratio, and alleviates the problem of city bicycle parking.

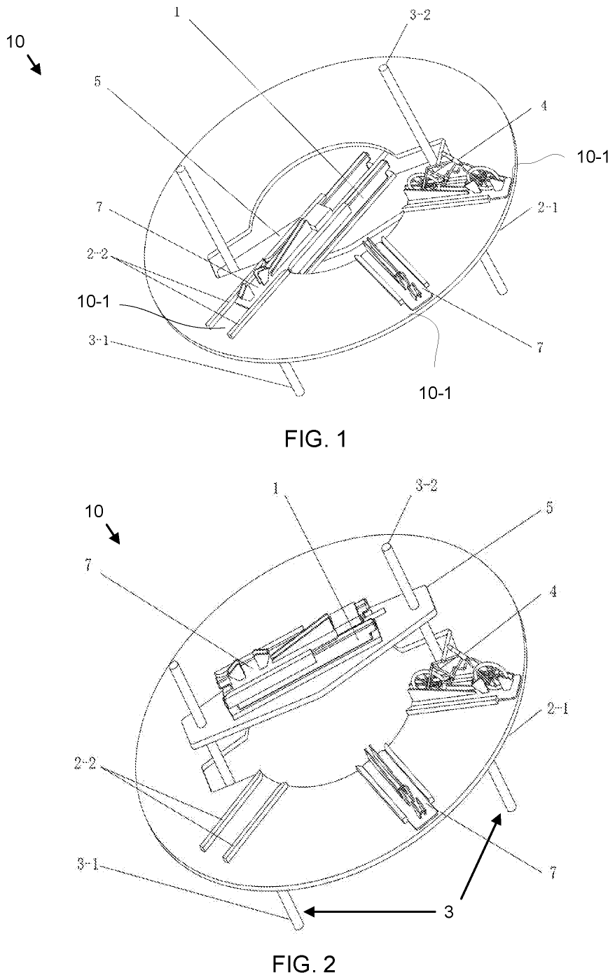

As showed in FIG. 1, the principal structure of the underground public bicycle parking device 10 is illustrated. The underground public bicycle parking device 10 comprises:

The storage tray 2-1 is located at the bottom of the bicycle parking device 10, and has a plurality of bicycle parking spaces 10-1;

The lifting mechanism 3 that drives a bicycle carrying platform 7 to move up and down.

The rotary platform 1 that is rotatably disposed on the lifting mechanism 3, and is docked with the bicycle parking space 10-1.

The bicycle carrying platform 7 transfers between the bicycle parking space 10-1 and the rotary platform 1 when parking a bicycle.

When user wants to park bicycle, the vacant bicycle carrying platform is placed on the rotary platform 1, and the lifting mechanism is raised to the ground. The bicycle is placed on the bicycle carrying platform 7. Subsequently the bicycle carrying platform 7 carrying the bicycle is lowered to the storage tray 2-1 by the lifting mechanism. The rotary platform 1 is rotated to dock with the corresponding vacant bicycle parking space 10-1, and the bicycle carrying platform 10-1 on the rotary platform 1 is pushed into the bicycle parking space 10-1.

When the bicycle is taken for use, the bicycle carrying platform 10-1 carrying the bicycle is brought into the rotary platform 1, and the bicycle is transported to the ground by the lifting mechanism.

The simulated public bicycle rental operation is as follows: A card reader or scanner is arranged on the ground portion of the device 10, and the card reader or scanner is connected with a background. When the user takes the bicycle, the user scans with the IC card or APP software. After obtaining the user information, the device 10 informs the background, and the background command is issued to control the corresponding bicycle carrying platform 7 to go up. After the user taking the bicycle, the controller learns that the state of the electronic lock on the bicycle carrying platform, and then transmits the status information to the background. Billable hours is counted from the background, and then the vacant bicycle carrying platform 7 is sent to the bicycle parking space 10-1 in the underground space; when the bicycle is returned, the user still scans with the integrated circuit (IC) card or application (APP) software. The card reader or scanner obtains the user information and sent this into the background, the background has already stored the user's car rental information, so the background judges that the user is returning the bicycle. Therefore, the vacant bicycle carrying platform 7 starts to go up. The user places the bicycle on the bicycle carrying platform 7, and locks. The lock action can be dealt by manual or APP control.

The central part of the storage tray 2-1 has an installation position, and the lifting mechanism is set at the installation position, and the lifting channel of the lifting mechanism is formed in the vertical direction of the installation position.

A motor (not shown) drives the first lifting screw 3-1 and the second lifting screw 3-2 synchronous rotation, such that the lifting platform 5. The rotary platform 1 is placed on the lifting platform 5, and can be rotated. When the rotary platform 1 is aligned with the guide limit rail 2-2, the bicycle carrying platform 7 can be moved from the rotary platform 1 to the guide limit rail 2-2, thereby completing the storage operation. If the device 10 has multiple storage trays 2-1, the device 10 can park more bicycles. As showed in FIG. 1, the bicycle carrying platform 7 is moving from the track of the rotary platform 1 to the guide limit rail 2-2, and the guide limit rail 2-2 forms the bicycle parking space. The guide limit rail 2-2 can guide the bicycle carrying platform in and out, and limit the bicycle carrying platform.

As shown in FIG. 2, the lifting mechanism 3 is going up or down. When parking, the rotary platform 1 obtains a vacant bicycle carrying platform 7 from the storage tray 2-1. After the lifting mechanism 3 rises to the ground level, the bicycle is parked thereon. After the bicycle is taken, the vacant bicycle carrying platform 7 is lowered by the lifting mechanism 3, and the vacant bicycle carrying platform 7 is transferred from the rotary platform 1 to the storage tray 2-1.

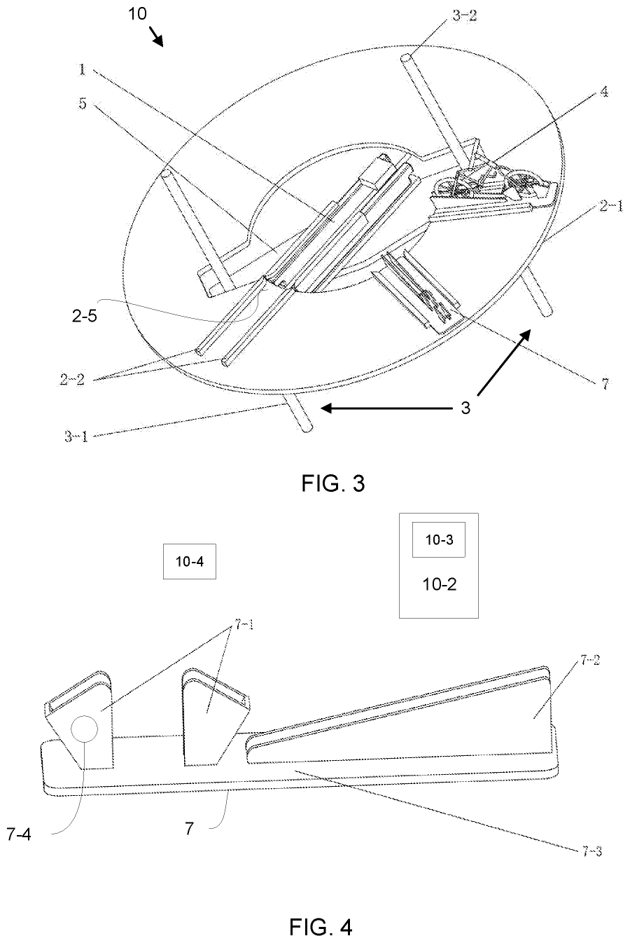

As shown in FIG. 3, the rotary platform 1 docks with bicycle parking spaces 10-1. The storage tray 2-1 is disk-shaped, and the bicycle parking space 10-1 is distributed along the radial direction of the storage tray 2-1. Bicycle can be arranged in a uniform arrangement. When the rotary platform 1 is docked with corresponding bicycle parking space 10-1, the rotary platform 1 and bicycle parking space 10-1 may transfer the bicycle carrying platform 7 to each other.

The lifting mechanism 3 includes the first lifting screw 3-1, the second lifting screw 3-2, and lifting platform 5. The first lifting screw 3-1 and the second lifting screw 3-2 are vertically disposed. Both sides of the lifting platform 5 respectively match up the first lifting screw 3-1 and the second lifting screw 3-2. When the first lifting screw 3-1 and the second lifting screw 3-2 rotate, they drive the lifting platform 5 up and down.

As shown in FIG. 4, the bicycle carrying platform 7 is illustrated. The bicycle carrying platform 7 includes a bicycle placement plate 7-3, the front wheel clamping structure 7-1 and the rear wheel clamping structure 7-2. And the front wheel clamping structure 7-1 and the rear wheel clamping structure 7-2 are set in the bicycle placement plate 7-3.

An electric lock 7-4 for locking the bicycle is disposed on the bicycle carrying platform 7. The electric lock 7-4 is connected to a controller 10-2 and the controller 10-2 detects the state of the electric lock 7-4 and user data, and transmits these to the background 10-4. The background 10-4 can count billable hours.

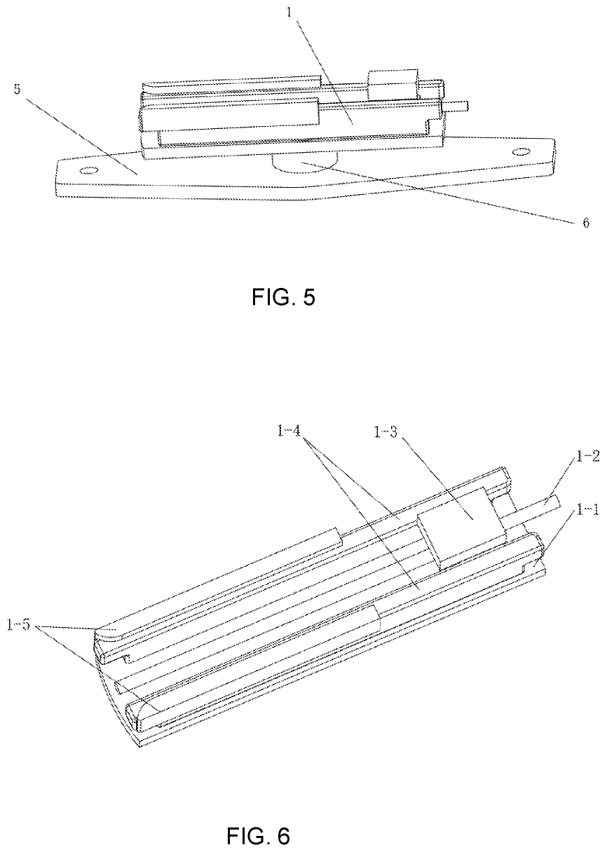

As shown in FIG. 5, the lifting platform 5 coordinates with the rotary platform 1. The rotary platform 1 is mounted on the lifting platform 5 via a rotary mechanism 6, and they can rotatably connect. The rotary mechanism 6 may be a rotating shaft in which bearing is disposed.

As showed in FIG. 6, the rotary platform 1 is illustrated. The rotary platform 1 includes rotating plate 1-1, translation screw 1-2, push block 1-3, supporting plate 1-4 and guide board 1-5. The translation screw 1-2, push block 1-3 and supporting plate 1-4 are installed on the rotating plate 1-1. The translation screw 1-2 through the push block 1-3. The guide board 1-5 set on the both sides of the rotating plate 1-1. The supporting plate 1-4 coordinates with the bicycle carrying platform. The supporting plate 1-4 is attached to the guide board 1-5, and is located at the both sides of the push block 1-3. The translation screw 1-2 rotates, so that the push block 1-3 moves, and push bicycle carrying platform 7 moves.

The push block 1-3 on the rotary platform 1 and bicycle carrying platform 7 are detachably connected. Push block 1-3 set an electromagnet. The electromagnet may attract the bicycle carrying platform 7 when the electromagnet powers on. The contact parts of the bicycle carrying platform 7 and push block 1-3 may be made of magnetic materials.

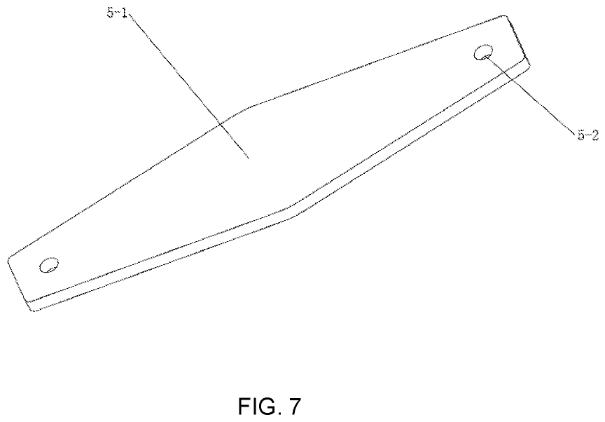

As showed in FIG. 7, the bottom plate 5-1 of lifting platform 5 is illustrated. The lifting platform 5 comprises the bottom plate 5-1. And the both side of bottom plate 5-1 include one or more threaded holes 5-2. Threaded hole 5-2 motivated by the first lifting screw 3-1 and the second lifting screw 3-2.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A bicycle parking device, including:
a storage tray located at the bottom of the bicycle parking device, and has a plurality of bicycle parking spaces;
a lifting mechanism that drives a bicycle carrying platform to move up and down;
a rotary platform that is rotatably disposed on the lifting mechanism, and is docked with the bicycle parking space; and
wherein the bicycle carrying platform transfers between the bicycle parking space and the rotary platform.

2. The bicycle parking device of claim 1, wherein the bicycle carrying platform has an electric lock that locks up the bike, the electric lock is connected to a controller, the controller detects the state of the electronic lock and user data, the controller comprises a wireless transmission module, the wireless transmission module sends data to the background, and the background calculates billable hours based on the data.

3. The bicycle parking device of claim 2, wherein the lifting mechanism includes a first lifting screw, a second lifting screw and a lifting platform, the first lifting screw and the second lifting screw are vertical set, both sides of the lifting platform respectively match up the first lifting screw and the second lifting screw, and in response to the first lifting screw and the second lifting screw rotating, the first lifting screw and the second lifting screw drive the lifting platform up and down.

4. The bicycle parking device of claim 2, wherein a central part of the storage tray has an installation position, and the lifting mechanism is set at the installation position, and the lifting channel of the lifting mechanism is formed in the vertical direction of the installation position.

5. The bicycle parking device of claim 2, wherein the guide limit rail forms the bicycle parking space, the guide limit rail guides the bicycle carrying platform in and out and limits the bicycle carrying platform.

6. The bicycle parking device of claim 2, wherein the rotary platform includes a rotating plate, a translation screw, a push block, a supporting plate and a guide board, wherein the translation screw, the push block and the supporting plate are installed on the rotating plate, the translation screw is set through the push block, the guide board is set on the both sides of the rotating plate, the supporting plate coordinates with the bicycle carrying platform, the supporting plate is attached to the guide board, and is located at the both sides of the push block, and the translation screw rotates, so that the push block moves and the push bicycle carrying platform moves.

7. The bicycle parking device of claim 6, wherein the push block and the bicycle carrying platform are detachably connected, the push block sets an electromagnet, the electromagnet attracts the bicycle carrying platform in response to being powered on, and the contact parts of bicycle carrying platform and push block are made of magnetic materials.

8. The bicycle parking device of claim 7, wherein bicycle carrying platform comprises a bicycle placement plate, a front wheel clamping structure and a rear wheel clamping structure, and wherein the front wheel clamping structure and the rear wheel clamping structure are set in the bicycles placed plate.

9. The bicycle parking device of claim 7, wherein the storage tray is disk-shaped, and the bicycle parking space is distributed along the radial direction of the storage tray.

10. The bicycle parking device of claim 7, wherein in response to a user wanting to park bicycle, the vacant bicycle carrying platform is placed on the rotary platform, the lifting mechanism is raised to the ground, the bicycle is placed on the bicycle carrying platform, the bicycle carrying platform carrying the bicycle is lowered to the storage tray by the lifting mechanism, the rotary platform is rotated to dock with the corresponding vacant bicycle parking space, and the bicycle carrying platform on the rotary platform is pushed into the bicycle parking space, and wherein in response to a user taking a bicycle, the bicycle carrying platform carrying the bicycle is brought into the rotary platform, and the bicycle is transported to the ground by the lifting mechanism.

11. A system comprising:
a controller;
a storage tray located at the bottom of the bicycle parking device, and has a plurality of bicycle parking spaces;
a lifting mechanism that drives a bicycle carrying platform to move up and down;
a rotary platform that is rotatably disposed on the lifting mechanism, and is docked with the bicycle parking space; and
wherein the bicycle carrying platform transfers between the bicycle parking space and the rotary platform as directed by the controller.

12. The system of claim 11, wherein the bicycle carrying platform has an electric lock that locks up the bike, the electric lock is connected to the controller, the controller detects the state of the electronic lock and user data, the controller comprises a wireless transmission module, the wireless transmission module sends data to the background, and the background calculates billable hours based on the data.

13. The system of claim 12, wherein the lifting mechanism includes a first lifting screw, a second lifting screw and a lifting platform, the first lifting screw and the second lifting screw are vertical set, both sides of the lifting platform respectively match up the first lifting screw and the second lifting screw, and in response to the first lifting screw and the second lifting screw rotating, the first lifting screw and the second lifting screw drive the lifting platform up and down.

14. The system of claim 12, wherein a central part of the storage tray has an installation position, and the lifting mechanism is set at the installation position, and the lifting channel of the lifting mechanism is formed in the vertical direction of the installation position.

15. The system of claim 12, wherein the guide limit rail forms the bicycle parking space, the guide limit rail guides the bicycle carrying platform in and out and limits the bicycle carrying platform.

16. The system of claim 12, wherein the rotary platform includes a rotating plate, a translation screw, a push block, a supporting plate and a guide board, wherein the translation screw, the push block and the supporting plate are installed on the rotating plate, the translation screw is set through the push block, the guide board is set on the both sides of the rotating plate, the supporting plate coordinates with the bicycle carrying platform, the supporting plate is attached to the guide board, and is located at the both sides of the push block, and the translation screw rotates, so that the push block moves and the push bicycle carrying platform moves.

17. The system of claim 16, wherein the push block and the bicycle carrying platform are detachably connected, the push block sets an electromagnet, the electromagnet attracts the bicycle carrying platform in response to being powered on, and the contact parts of bicycle carrying platform and push block are made of magnetic materials.

18. The system of claim 17, wherein bicycle carrying platform comprises a bicycle placement plate, a front wheel clamping structure and a rear wheel clamping structure, and wherein the front wheel clamping structure and the rear wheel clamping structure are set in the bicycles placed plate.

19. The system of claim 17, wherein the storage tray is disk-shaped, and the bicycle parking space is distributed along the radial direction of the storage tray.

20. The system of claim 17, wherein in response to a user wanting to park bicycle, the vacant bicycle carrying platform is placed on the rotary platform, the lifting mechanism is raised to the ground, the bicycle is placed on the bicycle carrying platform, the bicycle carrying platform carrying the bicycle is lowered to the storage tray by the lifting mechanism, the rotary platform is rotated to dock with the corresponding vacant bicycle parking space, and the bicycle carrying platform on the rotary platform is pushed into the bicycle parking space, and wherein in response to a user taking a bicycle, the bicycle carrying platform carrying the bicycle is brought into the rotary platform, and the bicycle is transported to the ground by the lifting mechanism.
